(19) United States
(12) Patent Application Publication
(10) Pub. No.: US 2014/0232659 A1
(43) Pub. Date: Aug. 21, 2014

(54) METHODS, APPARATUSES, AND COMPUTER PROGRAM PRODUCTS FOR EXECUTING FUNCTIONS BASED ON HOVER GESTURES OR TOUCH GESTURES

(71) Applicant: NOKIA CORPORATION, Espoo (FI)

(72) Inventor: Richard Collin, Saratoga, CA (US)

(73) Assignee: NOKIA CORPORATION, Espoo (FI)

(21) Appl. No.: 13/769,607

(22) Filed: Feb. 18, 2013

(51) Int. Cl. G06F 3/041

(52) U.S. Cl. CPC G06F 3/041
USPC 345/173

(57) ABSTRACT

Methods, apparatuses, and computer program products are herein provided for executing functions based on whether a hover gesture or a touch gesture is performed. A method may include receiving user input directed to a screen of a device and determining whether the user input is a hover gesture or a touch gesture. A touch gesture being defined by user input that contacts the screen. A hover gesture being defined by user input that does not contact the screen. The method may further include causing, in an instance in which the user input is determined to be the hover gesture, execution of a system function and causing, in an instance in which the user input is determined to be the touch gesture, execution of a content function. Corresponding apparatuses and computer program products are also provided.

### TECHNOLOGICAL FIELD

An example embodiment of the present invention relates generally to user interface technology and, more particularly, relates to methods, apparatuses, and computer program products for executing functions based on whether a hover gesture or a touch gesture is performed.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

Due to the increased functionality, some mobile computing devices can execute many different functions, each of which may have a specific user input associated with it. As such, there may be many different user inputs (e.g., different touch gestures), thereby making it difficult for a user to remember or execute the user input needed to cause execution of the intended function.

### BRIEF SUMMARY

Some of the functions capable of being performed by mobile computing devices may be related to the content being displayed on the user interface, while others may be related directly to the system of the mobile computing device. Moreover, often times, different functions may be associated with the same user input such that an unintended function may be performed when a user provides user input.

Some mobile computing devices include a user interface that uses a touch screen. The touch screen can receive user input directed to the screen and, in some cases, detect user input that is applied directly to the screen (e.g., a touch gesture) and user input that is applied a short distance from the screen (e.g., a hover gesture).

Example embodiments of the present invention provide for executing functions based on whether a hover gesture or a touch gesture is performed. In some embodiments, a certain type of function, such as a content function, can be performed when a touch gesture is received and another type of function, such as a system function, can be performed when a hover gesture is received. For example, in some embodiments, user input that defines a touch gesture may cause a content function to be executed while the same user input defined as a hover gesture may cause a system function to be executed. Such an example embodiment provides for intuitive differentiation of user input and associated functions by a user. For example, the user directly contacts the screen to cause execution of a content function.

In one example embodiment, a method includes receiving user input directed to a screen of a device. The method further includes determining whether the user input is a hover gesture or a touch gesture. The touch gesture is defined by user input that contacts the screen. The hover gesture is defined by user input that does not contact the screen. The method further includes causing, in an instance in which the user input is determined to be the hover gesture, execution of a system function. The method further includes causing, in an instance in which the user input is determined to be the touch gesture, execution of a content function.

In some embodiments, the method includes causing execution of the system function by causing execution of the system function irrespective of content displayed on the screen. In some embodiments, the method includes causing execution of the content function by causing execution of the content function within content being displayed on the screen. In some embodiments, the method includes causing execution of the system function by causing execution of a core navigation function of the device.

In some embodiments, the hover gesture is defined by user input that is detected to be at least a pre-determined distance away from the screen. In some embodiments, the hover gesture is defined by user input that is detected to be within a predefined range of distance away from the screen. Additionally, in some embodiments, the predefined range of distance defines a range of 10 mm to 15 mm away from the screen.

In some embodiments, the user input defines a slide user input directed to the screen in a predetermined direction. Additionally, the method may include causing execution of the content function by causing content being displayed on the screen to scroll in the predetermined direction. Further, the method may include causing execution of the system function by causing execution of one of a back function or an advance function.

In another example embodiment, an apparatus comprises at least one processor and at least one memory storing computer program code with the at least one memory and stored computer program code being configured, with the at least one processor, to cause the apparatus to receive user input directed to a screen of a device. The at least one memory and stored computer program code are configured, with the at least one processor, to further cause the apparatus to determine whether the user input is a hover gesture or a touch gesture. The touch gesture is defined by user input that contacts the screen. The hover gesture is defined by user input that does not contact the screen. The at least one memory and stored computer program code are configured, with the at least one processor, to further cause the apparatus to cause, in an instance in which the user input is determined to be the hover gesture, execution of a system function. The at least one memory and stored computer program code are configured, with the at least one processor, to further cause the apparatus to cause, in an instance in which the user input is determined to be the touch gesture, execution of a content function.

In another example embodiment, a computer program product is provided. The computer program product of this example embodiment includes at least one computer-readable storage medium having computer-readable program instructions stored therein. The program instructions of this example embodiment comprise program instructions configured to cause an apparatus to perform a method including receiving user input directed to a screen of a device. The method further includes determining whether the user input is a hover gesture or a touch gesture. The touch gesture is defined by user input that contacts the screen. The hover gesture is defined by user input that does not contact the screen. The method further includes causing, in an instance in which the user input is determined to be the hover gesture, execution of a system function. The method further includes causing, in an instance in which the user input is determined to be the touch gesture, execution of a content function.

In another example embodiment, an apparatus is provided. The apparatus comprises means for receiving user input directed to a screen of a device. The apparatus further comprises means for determining whether the user input is a hover gesture or a touch gesture. The touch gesture is defined by user input that contacts the screen. The hover gesture is defined by user input that does not contact the screen. The apparatus further comprises means for causing, in an instance in which the user input is determined to be the hover gesture, execution of a system function. The apparatus further comprises means for causing, in an instance in which the user input is determined to be the touch gesture, execution of a content function.

### BRIEF DESCRIPTION OF THE DRAWINGS

Having thus described some embodiments of the invention in general terms, reference will now be made to the accompanying drawings, which are not necessarily drawn to scale, and wherein:

FIG. 1 illustrates a block diagram of an apparatus according to an example embodiment of the present invention;

FIG. 2 is a schematic block diagram of a mobile terminal according to an example embodiment of the present invention;

FIGS. 3A and 3B illustrate example user inputs that may be received by an apparatus that may embody, for example, the apparatus shown in FIG. 1, in accordance with an example embodiment of the present invention described herein;

FIG. 4 illustrates an example apparatus, such as the apparatus shown in FIG. 1, with a user providing a touch gesture using their finger, in accordance with an example embodiment of the present invention described herein;

FIG. 4A shows a cross-sectional view of the apparatus shown in FIG. 4 taken along line 4A, with the user providing user input directly to a screen of the apparatus, in accordance with an example embodiment of the present invention described herein;

FIG. 5 illustrates an example apparatus, such as the apparatus shown in FIG. 1, with a user providing a hover gesture using their finger, in accordance with an example embodiment of the present invention described herein;

FIG. 5A shows a cross-sectional view of the apparatus shown in FIG. 5 taken along line 5A, with the user providing user input near, but not in direct contact with, a screen of the apparatus, in accordance with an example embodiment of the present invention described herein;

FIG. 6 illustrates an example apparatus, such as the apparatus shown in FIG. 1, with a user providing a touch gesture to a screen of the apparatus, wherein the screen is displaying content, in accordance with an example embodiment of the present invention described herein;

FIG. 6A shows a cross-sectional view of the apparatus shown in FIG. 6 taken along line 6A, with the user providing user input directly to the screen, in accordance with an example embodiment of the present invention described herein;

FIG. 7 illustrates the apparatus shown in FIG. 6, wherein a scroll function has been executed such that the content has been scrolled to the right, in accordance with an example embodiment of the present invention described herein;

FIG. 8 illustrates an example apparatus, such as the apparatus shown in FIG. 1, with a user providing a hover gesture to a screen of the apparatus, wherein the screen is displaying content, in accordance with an example embodiment of the present invention described herein;

FIG. 8A shows a cross-sectional view of the apparatus shown in FIG. 8 taken along line 8A, with the user providing user input near, but not in direct contact with, the screen, in accordance with an example embodiment of the present invention described herein;

FIG. 9 illustrates the apparatus shown in FIG. 8, wherein a back function has been executed such that previously-displayed content is being displayed, in accordance with an example embodiment of the present invention described herein; and

FIG. 10 illustrates a flowchart according to an example method for executing functions based on whether a hover gesture or a touch gesture is performed, in accordance with an example embodiment of the present invention described herein.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to singular or plural data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

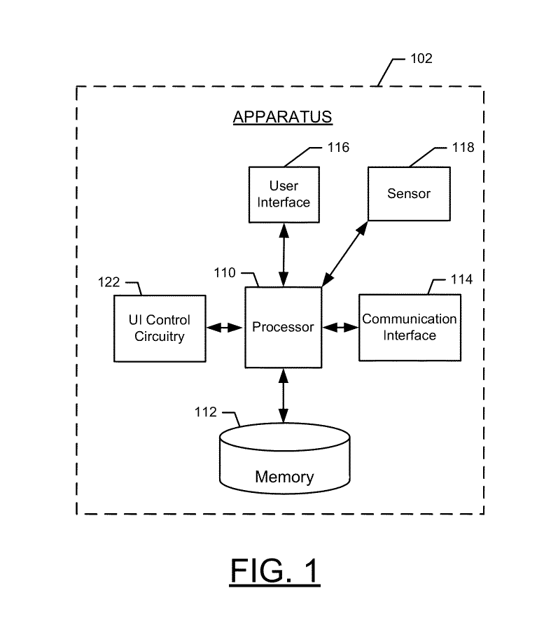

FIG. 1 illustrates a block diagram of an apparatus 102 configured for executing functions based on whether a hover gesture or a touch gesture is performed according to an example embodiment. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for performing operations and operational routing, other configurations may also be used to implement embodiments of the present invention.

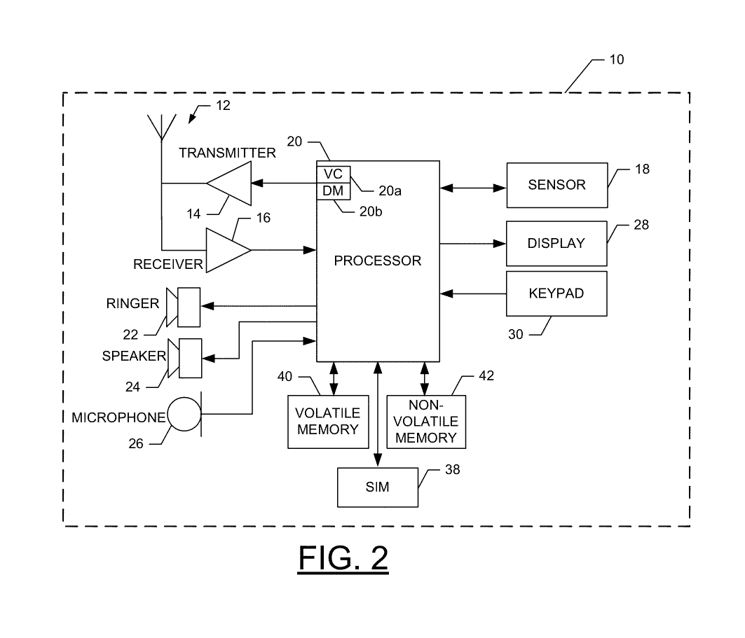

The apparatus 102 may be embodied as either a fixed device or a mobile device such as a desktop computer, laptop computer, mobile terminal, mobile computer, mobile phone, mobile communication device, game device, digital camera/camcorder, audio/video player, television device, radio receiver, digital video recorder, positioning device, a chipset, a computing device comprising a chipset, any combination thereof, and/or the like. In this regard, the apparatus 102 may comprise any computing device that comprises or is in operative communication with a user interface (e.g., a touch display capable of displaying a graphical user interface). In some example embodiments, the apparatus 102 is embodied as a mobile computing device, such as the mobile terminal illustrated in FIG. 2.

In this regard, FIG. 2 illustrates a block diagram of a mobile terminal 10 representative of one example embodiment of an apparatus 102. It should be understood, however, that the mobile terminal 10 illustrated and hereinafter described is merely illustrative of one type of apparatus 102 that may implement and/or benefit from various example embodiments of the invention and, therefore, should not be taken to limit the scope of the disclosure. While several embodiments of the electronic device are illustrated and will be hereinafter described for purposes of example, other types of electronic devices, such as mobile telephones, mobile computers, personal digital assistants (PDAs), pagers, laptop computers, desktop computers, gaming devices, positioning devices, tablet computers, televisions, e-papers, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of communicating according to Wi-Fi, Near Field Communications (NFC), BlueTooth, Worldwide Interoperability for Microwave Access (WiMAX) or other proximity-based communications protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a three-dimensional touch display, examples of which will be described further herein below. The user input interface may comprise devices allowing the mobile terminal to receive data, such as a keypad 30, a touch display (e.g., some example embodiments wherein the display 28 is configured as a touch display), a joystick (not shown), sensor 18, and/or other input device. In embodiments including a keypad, the keypad may comprise numeric (0-9) and related keys (#, *), and/or other keys for operating the mobile terminal 10. Alternatively or additionally, the keypad 30 may include a conventional QWERTY keypad arrangement.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the apparatus 102 includes various means for performing the various functions herein described. These means may comprise one or more of a processor 110, memory 112, communication interface 114, user interface 116, sensor 118, or user interface (UI) control circuitry 122. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, sensor 118, and/or UI control circuitry 122 may be embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, one or more other types of hardware processors, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20 (shown in FIG. 2). In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42 (shown in FIG. 2). The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, content, media content, user data, application data, and/or the like. This stored information may be stored and/or used by the UI control circuitry 122 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. In embodiments wherein the apparatus 102 is embodied as a mobile terminal 10, the communication interface 114 may be embodied as or comprise the transmitter 14 and receiver 16 (shown in FIG. 2). The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to receive and/or otherwise access content (e.g., web page content, streaming media content, and/or the like) over a network from a server or other content source. Additionally or alternatively, the communication interface 114 may be configured to support communications in accordance with any proximity-based protocol including, for example, Wi-Fi, NFC, BlueTooth, WiMAX or the like. The communication interface 114 may additionally be in communication with the memory 112, user interface 116, and/or UI control circuitry 122, such as via a bus.

The sensor 118 may be in communication with the processor 110, user interface 116, and/or UI control circuitry 122. The sensor 118 may be configured to sense and/or detect user input. Additionally, in some embodiments, the sensor 118 may be configured to detect or sense whether the user input directly contacts the user interface 116 (e.g., the touch screen). In such a manner, the sensor 118 may be configured to provide output indicative of whether the user input directly contacts the user interface 116 to the apparatus 102 (e.g., the processor 110). In embodiments wherein the apparatus 102 is embodied as a mobile terminal 10, the sensor 118 may be embodied as or comprise the sensor 18 (shown in FIG. 2). In some embodiments, the sensor 118 may comprise at least one of a pressure sensor, a proximity sensor, a light sensor, an accelerometer, or a gyroscope.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touchscreen display, a microphone, a speaker, and/or other input/output mechanisms. In some embodiments, a display may refer to display on a screen, on a wall, on glasses (e.g., near-eye-display), in the air, etc. In embodiments wherein the apparatus 102 is embodied as a mobile terminal 10, the user interface 116 may be embodied as or comprise the display 28 and keypad 30 (shown in FIG. 2). The user interface 116 may be in communication with the memory 112, communication interface 114, and/or UI control circuitry 122, such as via a bus.

The UI control circuitry 122 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In some example embodiments wherein the UI control circuitry 122 is embodied separately from the processor 110, the UI control circuitry 122 may be in communication with the processor 110. The UI control circuitry 122 may further be in communication with one or more of the memory 112, communication interface 114, or user interface 116, such as via a bus.

The UI control circuitry 122 may be configured to receive user input from a user interface 116, such as a touch display (e.g., touch screen). The user input or signal may carry positional information indicative of the user input. In this regard, the position may comprise a position of the user input in a two-dimensional space, which may be relative to the surface of the touch display user interface. For example, the position may comprise a coordinate position relative to a two-dimensional coordinate system (e.g., an X and Y axis), such that the position may be determined. Accordingly, the UI control circuitry 122 may determine a position of the user input such as for determining a portion of the display to which the user input correlates.

The touch display may also be configured to enable the detection of a hover gesture input. A hover gesture input may comprise a gesture input to the touch display without making physical (e.g., direct) contact with a surface of the touch display, such as a gesture made in a space some distance above/in front of the surface of the touch display. As an example, the touch display may comprise a capacitive touch display, which may be configured to enable detection of capacitance of a finger or other input object by which a gesture may be made without physically contacting a display surface. As another example, the touch display may be configured to enable detection of a hover gesture input through use of acoustic wave touch sensor technology, electromagnetic touch sensing technology, near field imaging technology, optical sensing technology, infrared proximity sensing technology, some combination thereof, or the like.

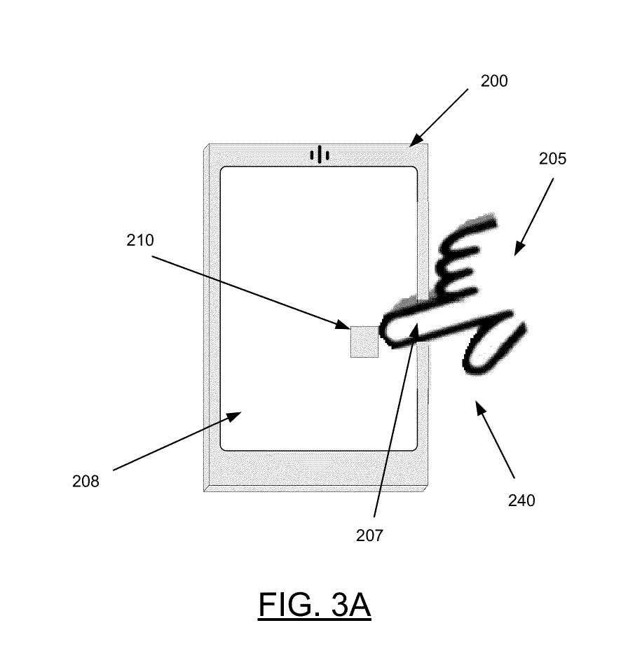

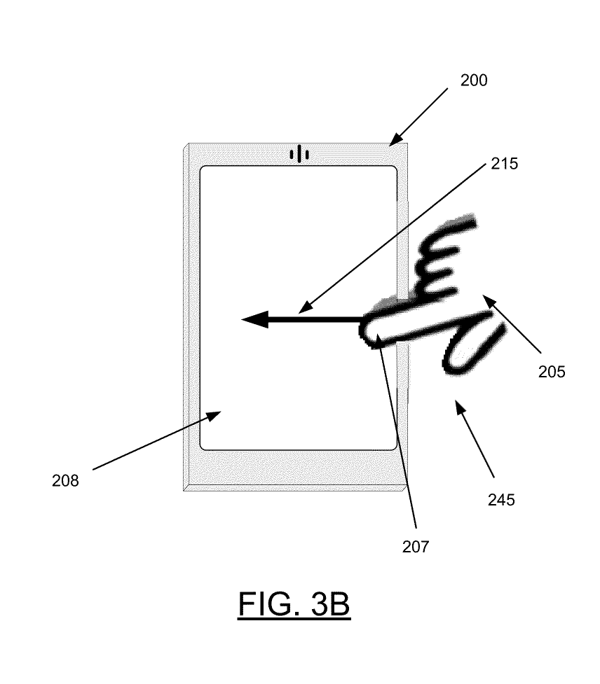

The apparatus 102 may be configured to receive input on a touch display (e.g., user interface 116). The user input may indicate a user's desire for the apparatus 102 to execute a designated function (e.g., run an application, load a website, scroll through a document, etc.). In some embodiments, the different components and/or abilities of the apparatus 102 may determine the types of functions able to be performed. Some examples of gestures are shown in FIGS. 3A and 3B.

FIG. 3A illustrates an example user input 240 for an apparatus 200 (e.g., apparatus 102) with a touch display 208 (e.g., user interface 116). In the depicted embodiment, a user 205 positions their finger 207 on or near the display, and particularly, on or near a portion 210 of the display. In some embodiments, the portion 210 of the display may correspond to a pre-determined point that is associated with a desired function. In other words, the portion 210 may correlate to a function that can be performed by the apparatus 200 (e.g., an icon representing an application). For example, the portion 210 may correlate to an application that grants access to the internet. Likewise, the portion 210 may correspond to another function, such as a hyperlink, game application, etc. Thus, by placing a finger 207 on or near the portion 210 (e.g., “pointing”), the user 205 is indicating a desire for the apparatus 200 to perform that related function (e.g., open the internet, access the linked website, launch the game application, etc.). Based on the user input detected, the apparatus 102 may respond, causing execution of the desired function.

FIG. 3B illustrates another example user input 245, often referred to as a “slide” user input, for an apparatus 200 (e.g., apparatus 102) with a touch display 208 (e.g., user interface 116). In the depicted embodiment, a user 205 positions a finger 207 on or near a portion of the display. The user 205 may slide their finger 207 along the display 208 (e.g., along arrow 215). In some embodiments, a user may slide their finger in a generally linear direction to define a slide user input. This user input often corresponds to a user's desire to “scroll” or move the display to show displayed content that may be currently off the display. Based on the user input detected by the user interface 116, the processor 110 and/or UI control circuitry 122 may respond (e.g., scrolling the previously un-displayed content onto the display for the user).

As indicated above, there are many types of user inputs that are recognizable by apparatus 102. Some additional known user inputs include pinching or reverse pinching for zooming out or zooming in, respectively.

In some embodiments, the apparatus 102, such as through the user interface 116 and/or UI control circuitry 122, may be configured to receive user input directed to a screen (e.g., the user interface 116, such as a touch screen) of a device (e.g., the apparatus 102). However, as noted herein, user input may be directed to the screen in different ways. For example, in embodiments in which the user interface 116 defines a touch screen, user input may be provided to the touch display (e.g., screen) as a touch gesture or as a hover gesture.

In some embodiments, the apparatus 102, such as through the processor 110, may be configured to determine whether the user input is a hover gesture or a touch gesture. A touch gesture may be defined by user input that contacts the screen. A hover gesture may be defined by user input that does not contact the screen.

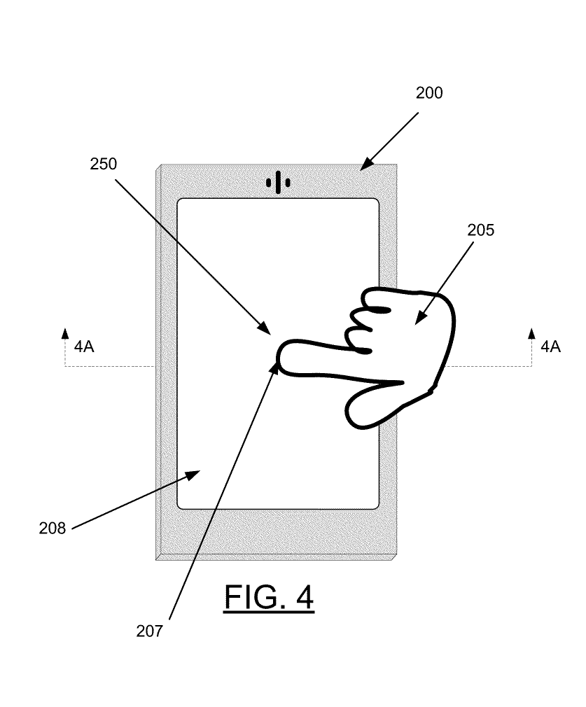

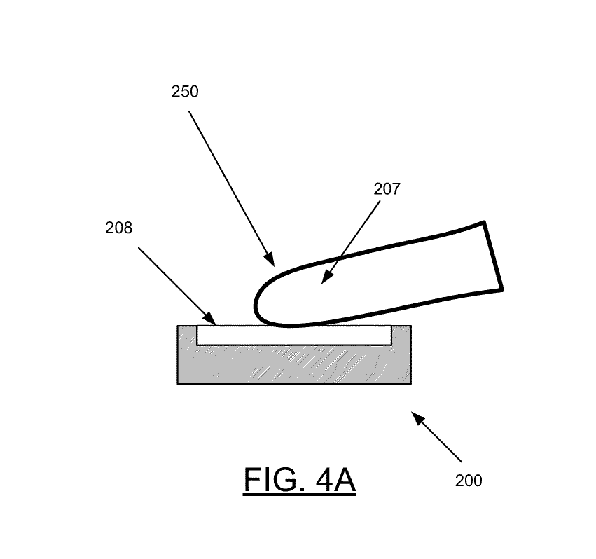

FIGS. 4-4A illustrate an example touch gesture 250. With reference to FIG. 4, a user 205 performs the touch gesture 250 by positioning their finger 207 directly on the screen 208 of the apparatus 200. As shown in FIG. 4A, the finger 207 of the user 205 is in direct contact with the screen 208.

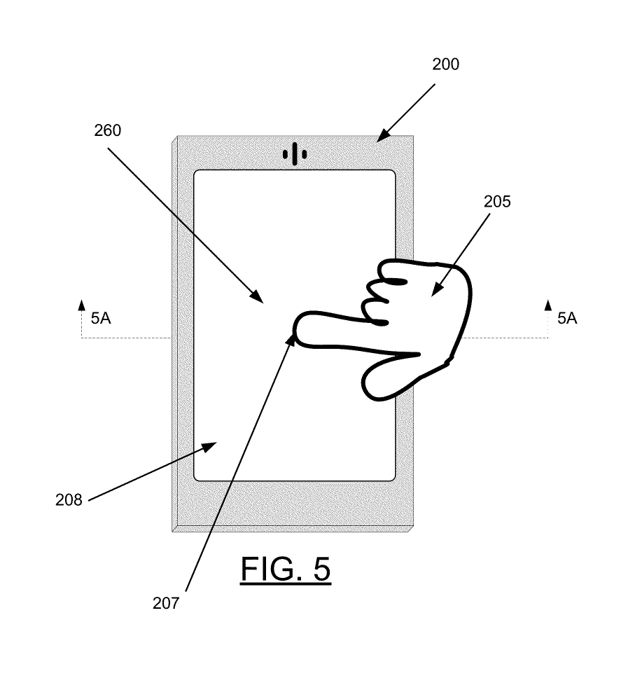

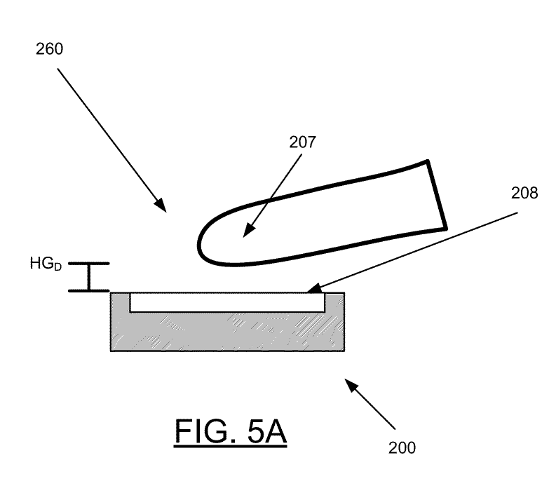

FIGS. 5-5A illustrate an example hover gesture 260. With reference to FIG. 5, a user 205 performs the hover gesture 260 by positioning their finger 207 directly over, but not on, the screen 208 of the apparatus 200. As shown in FIG. 5A, the finger 207 of the user 205 is disposed a distance HG_{D} away from the screen 208 such that it is not directly contacting the screen 208.

In some embodiments, the hover gesture may be defined by user input that is detected to be at least a pre-determined distance away from the screen. Additionally or alternatively, the hover gesture may be defined by user input that is detected to be within a predefined range of distance away from the screen. For example, in some embodiments, the predefined range of distance may define a range of 10 mm to 15 mm away from the screen. In such an embodiment, the apparatus may be configured to determine that a user input is a hover gesture if the finger of the user is at least 10 mm away from the screen, but no further than 15 mm away from the screen.

With reference to FIGS. 4-4A and FIGS. 5-5A, even though the user 205 performs the “same” user input with their finger 207 (e.g., positioning their finger 207 in a similar horizontal position with respect to the screen), a different user input is determined to be performed based on whether the user actually contacts the screen with their finger 207. As used herein, the term “same user input” may refer to user input that is identical (e.g., horizontal position, movement, etc.) but for the difference in whether or not the user input includes direct contact with the screen. Though the above described embodiments only depict a pointing user input, other types of user input are contemplated and may be differentiated between based on whether the user input directly contacts the screen.

As noted above, apparatuses, such as apparatus 102, may be configured to execute many different functions, including different types of functions (e.g., content functions and systems functions). In some embodiments, the apparatus 102, such as through the processor 110, may be configured to cause execution of a content function. A content function may be related to the content being displayed on the user interface 116 (e.g., the screen) and may cause a function to be directly applied to the displayed content. In some embodiments, the apparatus 102, such as through the processor 110, may be configured to cause execution of a content function within content being displayed on the user interface 116. For example, the content may define a website and only a portion of the website may be displayed on the user interface 116 of the apparatus 102. An example content function may comprise scrolling display of the website such that another portion of the website is displayed on the user interface 116. Other example content functions may include zooming in or out of the display of the content. While the above described embodiment details scrolling functions or zooming functions, other content functions are contemplated.

In some embodiments, the apparatus 102, such as through the processor 110, may be configured to cause execution of a system function. A system function may be related directly to the system of the apparatus 102, such as the core functionality or navigation of the apparatus 102. For example, the system function may comprise returning to a home screen of the apparatus 102, such as may be used to show possible applications or tasks for use on the apparatus.

In some embodiments, the apparatus 102, such as through the processor 110, may be configured to cause execution of a system function irrespective of content being displayed on the user interface 116. For example, content defining a website may be displayed on the user interface 116 of the apparatus 102. However, a system function may include returning to a home website (e.g., a home page). In such an example, the function of returning to the home website occurs irrespective of the content being displayed. Indeed, the content being displayed is irrelevant to the example system function of returning to a home website. While the above described embodiments detail returning to a home screen or home website as example system functions, other system functions are contemplated.

As noted above, often times, different functions may be associated with the same user input such that an unintended function may be performed when a user provides user input. For example, a slide user input may be associated with both scrolling content being displayed on a screen and a back function in a browser. Thus, in some cases, it may be difficult for a user to cause execution of the intended function.

As such, some example embodiments of the present invention provide for executing functions based on whether a hover gesture or a touch gesture is performed. In some embodiments, the apparatus 102, such as through the processor 110, may be configured to cause, in an instance in which the user input is determined to be a touch gesture, execution of a content function. Likewise, the apparatus 102, such as through the processor 110, may be configured to cause, in an instance in which the user input is determined to be a hover gesture, execution of a system function.

In some embodiments, a touch gesture may cause a content function to be executed while the same user input as a hover gesture may cause a system function to be executed. Such an example embodiment provides for intuitive differentiation for a user. For example, the user may mentally associate pressing on (e.g., directly contacting) the screen (or the content displayed on the screen) with intending execution of a content function.

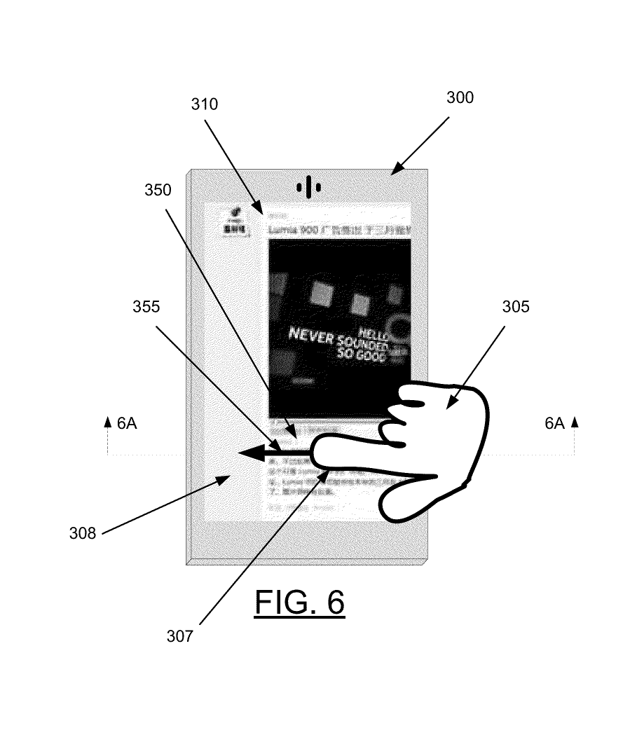

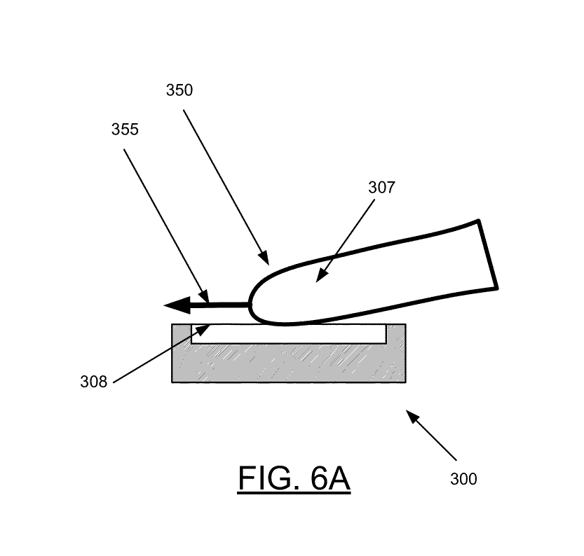

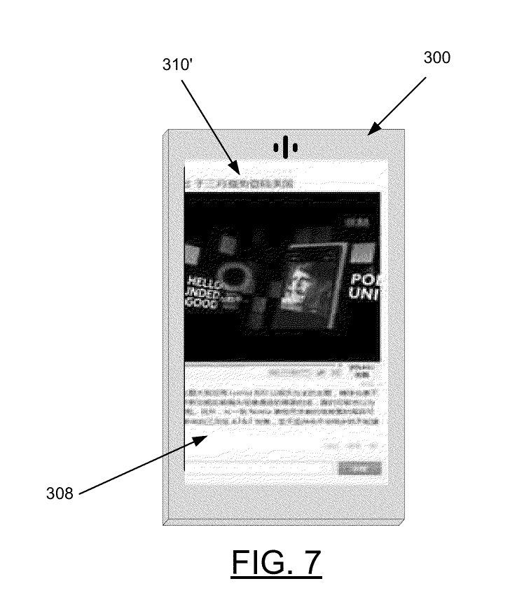

In some embodiments, the apparatus 102, such as through the processor 110, may be configured to cause, in an instance in which the user input is determined to be a touch gesture, execution of a content function. In some embodiments, the apparatus 102, such as through the processor 110, may be configured to cause execution of the content function by causing content being displayed on the screen to scroll in a predetermined direction, such as the direction of a slide user input. For example, with reference to FIG. 6, the apparatus 300 (e.g., apparatus 102) includes a screen 308 displaying a portion of a website 310. Additionally, a user 305 is providing a user input 350 directed to the screen 308. In particular, a finger 307 of the user 305 may slide along arrow 355 to perform a slide user input. With reference to FIG. 6A, the finger 307 of the user 305 directly contacts the screen 308 during performance of the user input 350. As such, the apparatus 300 determines that the user input 350 defines a touch gesture. Then, with reference to FIG. 7, the apparatus 300 causes execution of a content function associated with the user input 350. In particular, the apparatus 300 causes execution of a scrolling function such that the website 310 is scrolled to the right (e.g., in the direction of the user input 350) and a different portion 310′ of the website 310 is displayed on the screen 308.

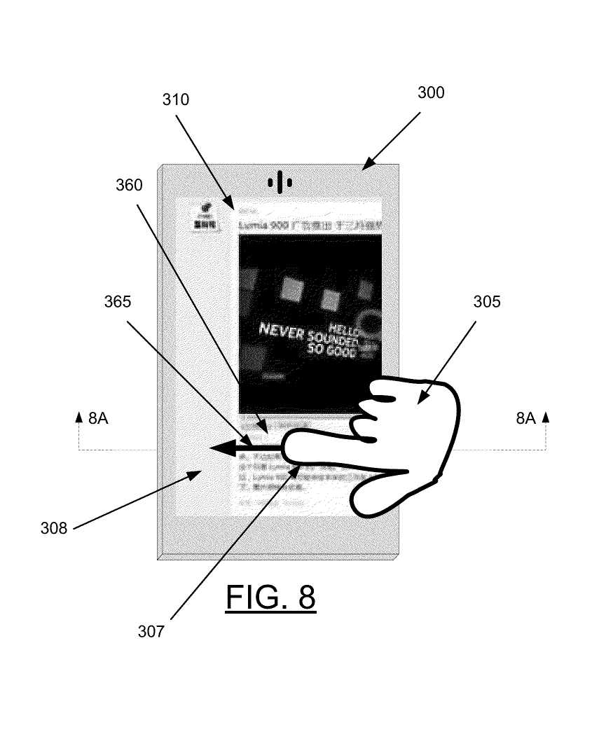

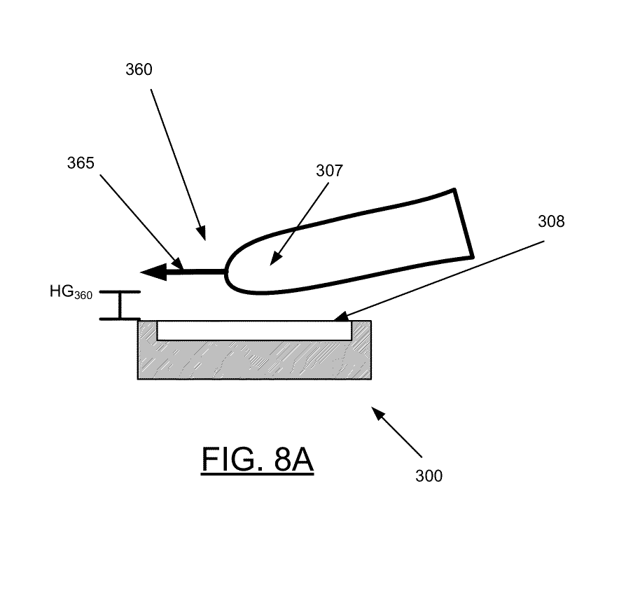

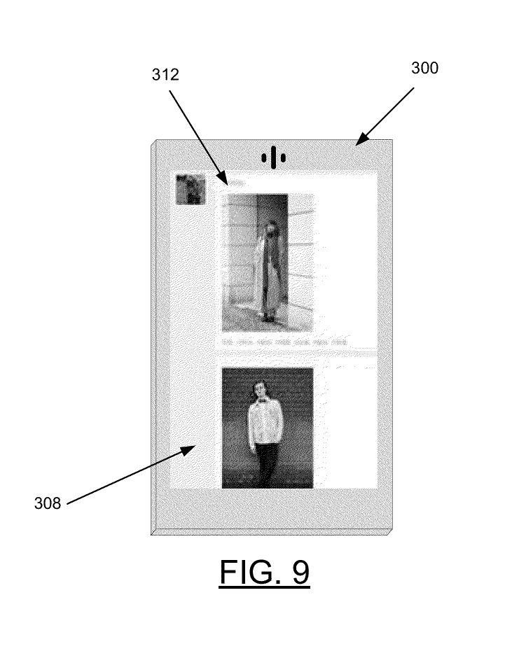

In some embodiments, the apparatus 102, such as through the processor 110, may be configured to cause, in an instance in which the user input is determined to be a hover gesture, execution of a system function. In some embodiments, the apparatus 102, such as through the processor 110, may be configured to cause execution of the system function by causing execution of one of a back function or an advance function. For example, with reference to FIG. 8, the apparatus 300 (e.g., apparatus 102) includes a screen 308 displaying a portion of a website 310. Additionally, a user 305 is providing a user input 360 directed to the screen 308. In particular, a finger 307 of the user 305 may slide along arrow 365 to perform a slide user input. With reference to FIG. 8A, the finger 307 of the user 305 does not directly contact the screen 308 during performance of the user input 360. In particular, the finger 307 is disposed a distance HG₃₆₀ away from the screen 308. As such, the apparatus 300 determines that the user input 350 defines a hover gesture. Then, with reference to FIG. 9, the apparatus 300 causes execution of a system function associated with the user input 360. In particular, the apparatus 300 causes execution of a back function such that the previously displayed website 312 is displayed on the screen 308.

Though the above described embodiments detail a slide user input, some embodiments of the present invention contemplate other user inputs (e.g., pointing, pinch, reverse pinch, etc.). Additionally, though the above described embodiments detail a scrolling function as a content function executed in response to a slide user input that is a touch gesture, other content functions are contemplated. Along these lines, though the above described embodiments detail a back function as a system function executed in response to a slide user input that is a hover gesture, other system functions are contemplated.

Some embodiments of the present invention provide a number of advantages. For example, as noted herein, some embodiments provide for performance of simpler and more intuitive user inputs for causing execution of desired functions. Furthermore, some embodiments provide for a greater range of options for associating user inputs with functions. Indeed, using a differentiation between touch gestures and hover gestures can allow for at least twice as many options for user inputs.

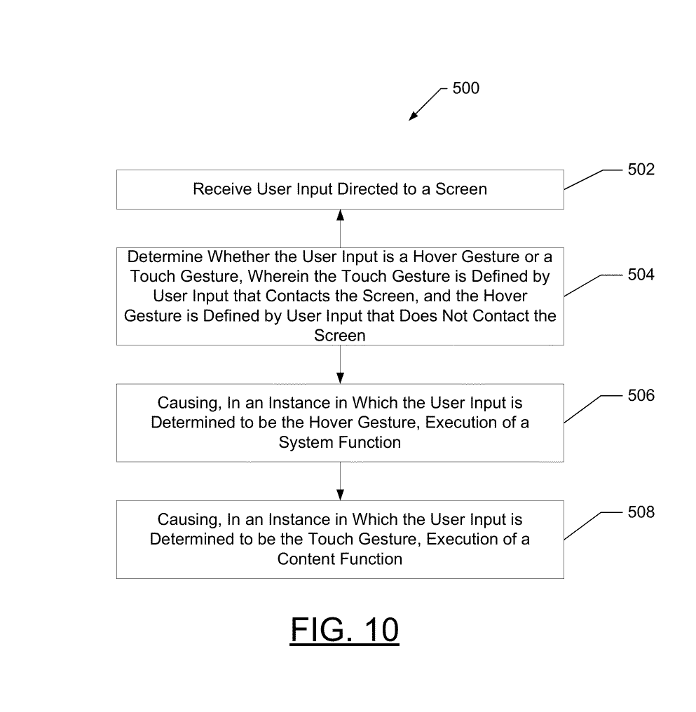

Embodiments of the present invention provide methods, apparatus and computer program products for executing functions based on whether a hover gesture or a touch gesture is performed. Various examples of the operations performed in accordance with embodiments of the present invention will now be provided with reference to FIG. 10.

FIG. 10 illustrates a flowchart according to another example method for executing functions based on whether a hover gesture or a touch gesture is performed according to an example embodiment 500. The operations illustrated in and described with respect to FIG. 10 may, for example, be performed by, with the assistance of, and/or under the control of one or more of the processor 110, memory 112, communication interface 114, user interface 116, sensor 118, or UI control circuitry 122. Operation 502 may comprise receiving user input directed to a screen of a device. The user interface 116, sensor 118, and/or UI control circuitry 122 may, for example, provide means for performing operation 502. Operation 504 may comprise determining whether the user input is a hover gesture or a touch gesture. The touch gesture is defined by user input that contacts the screen. The hover gesture is defined by user input that does not contact the screen. The processor 110 may, for example, provide means for performing operation 504. Operation 506 may comprise causing, in an instance in which the user input is determined to be the hover gesture, execution of a system function. The processor 110 may, for example, provide means for performing operation 506. Operation 508 may comprise causing, in an instance in which the user input is determined to be the touch gesture, execution of a content function. The processor 110 may, for example, provide means for performing operation 508.

FIG. 10 illustrates a flowchart of a system, method, and computer program product according to an example embodiment. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowchart, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
receiving user input directed to a screen of a device;
determining, by a processor, whether the user input is a hover gesture or a touch gesture, wherein a touch gesture is defined by user input that contacts the screen, and a hover gesture is defined by user input that does not contact the screen;
causing, in an instance in which the user input is determined to be a hover gesture, execution of a system function; and
causing, in an instance in which the user input is determined to be a touch gesture, execution of a content function.

2. The method according to claim 1, wherein causing execution of the system function comprises causing execution of the system function irrespective of content displayed on the screen.

3. The method according to claim 1, wherein causing execution of the content function comprises causing execution of the content function within content being displayed on the screen.

4. The method according to claim 1, wherein causing execution of the system function comprises causing execution of a core navigation function of the device.

5. The method according to claim 1, wherein the hover gesture is defined by user input that is detected to be at least a pre-determined distance away from the screen.

6. The method according to claim 1, wherein the hover gesture is defined by user input that is detected to be within a predefined range of distance away from the screen.

7. The method according to claim 6, wherein the predefined range of distance defines a range of 10 mm to 15 mm away from the screen.

8. The method according to claim 1, wherein the user input defines a slide gesture directed to the screen in a predetermined direction, wherein causing execution of the content function comprises causing content being displayed on the screen to scroll in the predetermined direction, and wherein causing execution of the system function comprises causing execution of one of a back function or an advance function.

9. An apparatus comprising a processor and a memory including computer program code, the memory and the computer program code configured to, with the processor, cause the apparatus to:
receive user input directed to a screen of a device;
determine whether the user input is a hover gesture or a touch gesture, wherein a touch gesture is defined by user input that contacts the screen, and a hover gesture is defined by user input that does not contact the screen;
cause, in an instance in which the user input is determined to be a hover gesture, execution of a system function; and
cause, in an instance in which the user input is determined to be a touch gesture, execution of a content function.

10. The apparatus of claim 9, wherein the memory and the computer program code are further configured to, with the processor, cause the apparatus to cause execution of the system function by causing execution of the system function irrespective of content displayed on the screen.

11. The apparatus of claim 9, wherein the memory and the computer program code are further configured to, with the processor, cause the apparatus to cause execution of the content function by causing execution of the content function within content being displayed on the screen.

12. The apparatus of claim 9, wherein the memory and the computer program code are further configured to, with the processor, cause the apparatus to cause execution of the system function by causing execution of a core navigation function of the device.

13. The apparatus of claim 9, wherein the hover gesture is defined by user input that is detected to be at least a pre-determined distance away from the screen.

14. The apparatus of claim 9, wherein the hover gesture is defined by user input that is detected to be within a predefined range of distance away from the screen.

15. The apparatus of claim 14, wherein the predefined range of distance defines a range of 10 mm to 15 mm away from the screen.

16. The apparatus of claim 9, wherein the user input defines a slide gesture directed to the screen in a predetermined direction, wherein the memory and the computer program code are further configured to, with the processor, cause the apparatus to cause execution of the content function by causing content being displayed on the screen to scroll in the predetermined direction, and wherein the memory and the computer program code are further configured to, with the processor, cause the apparatus to cause execution of the system function by causing execution of one of a back function or an advance function.

17. A computer program product comprising a non-transitory computer readable medium having program code portions stored thereon, the program code portions being configured when said program product is run on a processor, to:
receive user input directed to a screen of a device;
determine whether the user input is a hover gesture or a touch gesture, wherein a touch gesture is defined by user input that contacts the screen, and a hover gesture is defined by user input that does not contact the screen;
cause, in an instance in which the user input is determined to be a hover gesture, execution of a system function; and
cause, in an instance in which the user input is determined to be a touch gesture, execution of a content function.

18. The computer program product of claim 17, wherein the program code portions are further configured, when said program product is run on a processor, to cause execution of the system function by causing execution of the system function irrespective of content displayed on the screen.

19. The computer program product of claim 17, wherein the program code portions are further configured, when said program product is run on a processor, to cause execution of the content function by causing execution of the content function within content being displayed on the screen.

20. The computer program product of claim 17, wherein the hover gesture is defined by user input that is detected to be at least a pre-determined distance away from the screen.
